(19) United States
(12) Patent Application Publication
(10) Pub. No.: US 2018/0348531 A1
(43) Pub. Date: Dec. 6, 2018

(54) METHOD EXECUTED ON COMPUTER FOR CONTROLLING A DISPLAY OF A HEAD MOUNT DEVICE, PROGRAM FOR EXECUTING THE METHOD ON THE COMPUTER, AND INFORMATION PROCESSING APPARATUS THEREFOR

(71) Applicant: COLOPL, Inc., Tokyo (JP)

(72) Inventor: Keisuke NAKAHARA, Tokyo (JP)

(21) Appl. No.: 15/993,817

(22) Filed: May 31, 2018

(30) Foreign Application Priority Data
May 31, 2017 (JP) 2017-108236

(51) Int. Cl. G02B 27/01; H04N 21/236; G06F 3/01; G06T 15/20

(52) U.S. Cl. CPC G02B 27/0179; G02B 27/017; G02B 2027/0187; G06F 3/012; G06T 15/20; H04N 21/23614

(57) ABSTRACT

A method according to at least one embodiment of this disclosure includes detecting a motion of a head-mounted device (HMD) associated with a first user. The method further includes outputting to the HMD a video corresponding to the motion of the HMD. The method further includes outputting the video to a display terminal associated with a second user different from the first user. The method further includes receiving input associated with the video from the display terminal by receiving input to the display terminal by the second user. The method further includes outputting an image corresponding to the input to the HMD.

### TECHNICAL FIELD

This disclosure relates to a technology for providing a virtual space by using a head-mounted device, and more particularly, to a technology for presenting a comment in the virtual space.

### BACKGROUND

A computer for executing video distribution, game programs, and the like generates a video signal corresponding to play of a commentator. The computer (or another device that has received the video signal) transmits a live video to a distribution server. The distribution server transmits the live video to one or more other terminals connected and logged in to the distribution server. The distribution server receives inputs of comments from any one of the terminals, and transmits the received comments to other terminals as required. As a result, while the commentator is referring to comments from live viewers, the commentator and the viewers can both enjoy an interaction in which the commentator is commentating on his or her play.

For example, regarding a technology for displaying a comment of a user in distribution of a moving image, in WO 2016/039156 (Patent Document 1), there is described a technology capable of “reducing user effort when communicating information on a moving image managed by a moving image distribution system for distributing moving images by a terminal different from a moving image transmission apparatus for transmitting moving images distributed by live streaming”.

### PATENT DOCUMENT

[Patent Document 1] WO 2016/039156 A1

### SUMMARY

According to one embodiment of this disclosure, there is provided a method of controlling display of a head-mounted device (HMD), the method including: detecting a motion of the HMD associated with a first user; outputting to the HMD a video corresponding to the motion of the HMD; outputting the video to a display terminal associated with a second user different from the first user; receiving input associated with the video from the display terminal by receiving input to the display terminal by the second user; and outputting an image corresponding to the input to the HMD

The above-mentioned and other objects, features, aspects, and advantages of this disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14A A diagram of a transition of the screen displayed on the monitor 130 providing the virtual space according to at least one embodiment of this disclosure.

FIG. 14B A diagram of a transition of the screen displayed on the monitor 130 providing the virtual space according to at least one embodiment of this disclosure.

FIG. 14C A diagram of a transition of the screen displayed on the monitor 130 providing the virtual space according to at least one embodiment of this disclosure.

FIG. 15 A schematic diagram of a configuration for adding a comment to the image presented in the virtual space according to at least one embodiment of this disclosure.

FIG. 16 A block diagram of a detailed configuration of the modules of the computer according to at least one embodiment of this disclosure.

FIG. 17 A block diagram of a configuration of functions implemented by a server computer 605 according to at least one aspect of this disclosure.

FIG. 18 A schematic diagram of one mode of storing data in a storage 1710 according to at least one embodiment of this disclosure.

FIG. 19 A flowchart of a part of processing to be executed when the server computer 605 is implemented by the computer 200 according to at least one embodiment of this disclosure.

FIG. 20 A flowchart of a part of processing to be executed when the server computer 605 is implemented by the server 600 according to at least one embodiment of this disclosure.

FIG. 21 A flowchart of a part of processing to be executed by an external device 700A of another user according to at least one embodiment of this disclosure.

FIG. 22 A diagram of an example of the screen displayed on a monitor 720 of the external device 700A according to at least one embodiment of this disclosure.

FIG. 23A A schematic diagram of a flow of data generation for displaying an image on the monitor 130 according to at least one embodiment of this disclosure.

FIG. 23B A schematic diagram of a flow of data generation for displaying an image on the monitor 130 according to at least one embodiment of this disclosure.

FIG. 23C A schematic diagram of a flow of data generation for displaying an image on the monitor 130 according to at least one embodiment of this disclosure.

FIG. 24 A diagram of one mode of a screen on which a comment input by the user 5 is displayed on the monitor 720 of a user terminal of another user according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

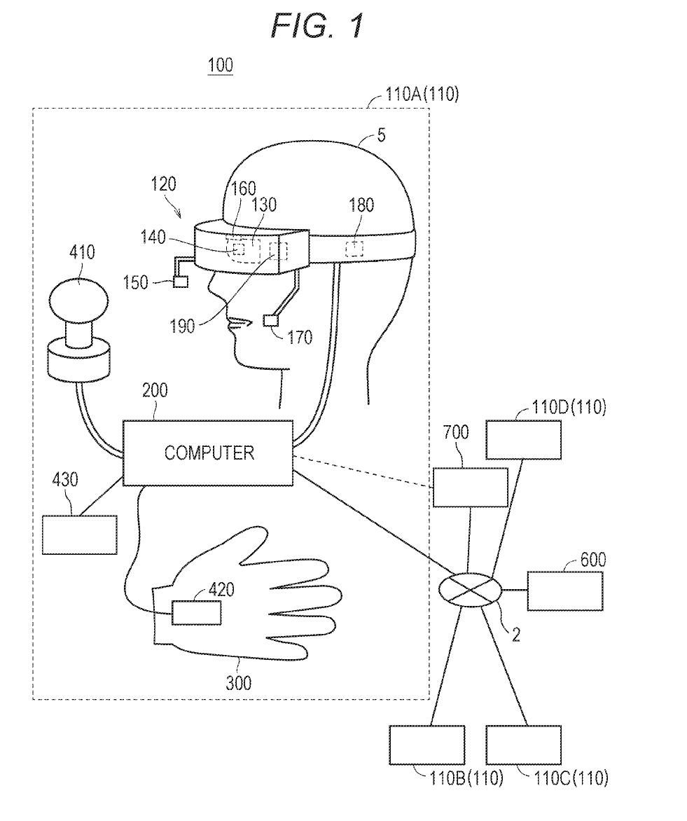

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smart glasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth™ or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

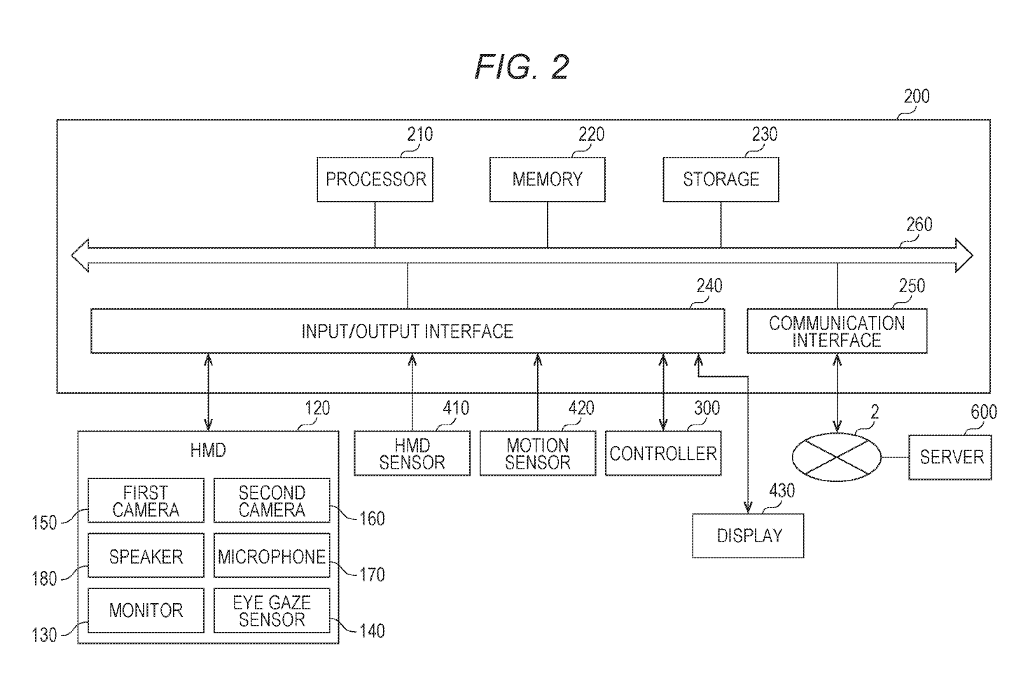

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-field Coordinate System]

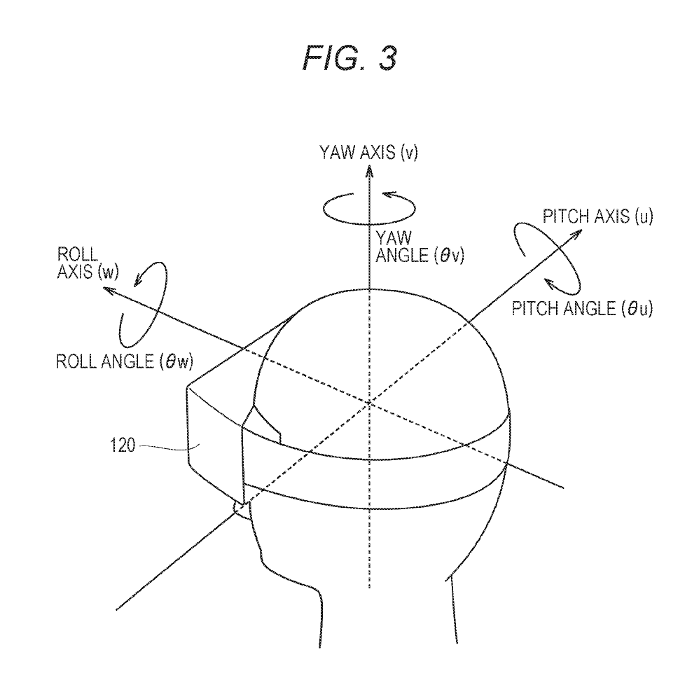

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

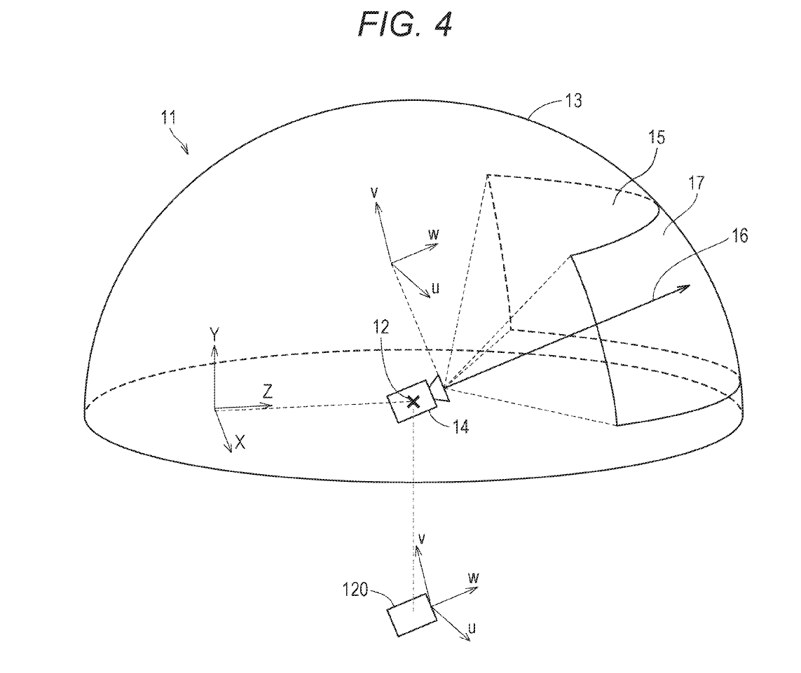

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

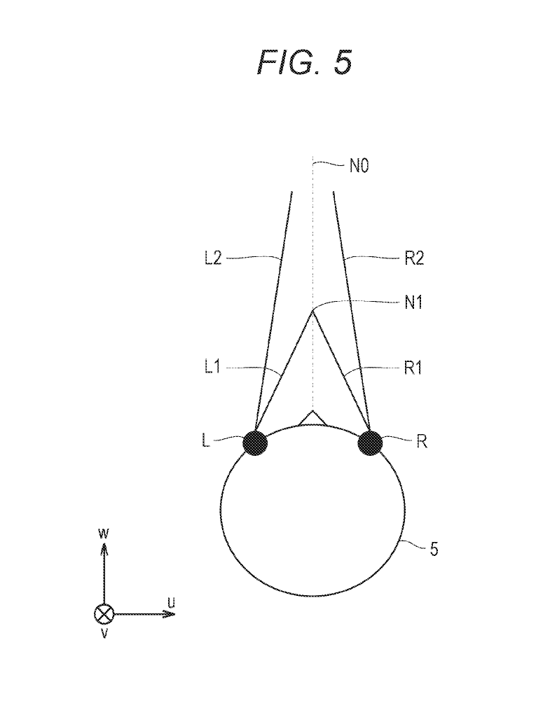

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

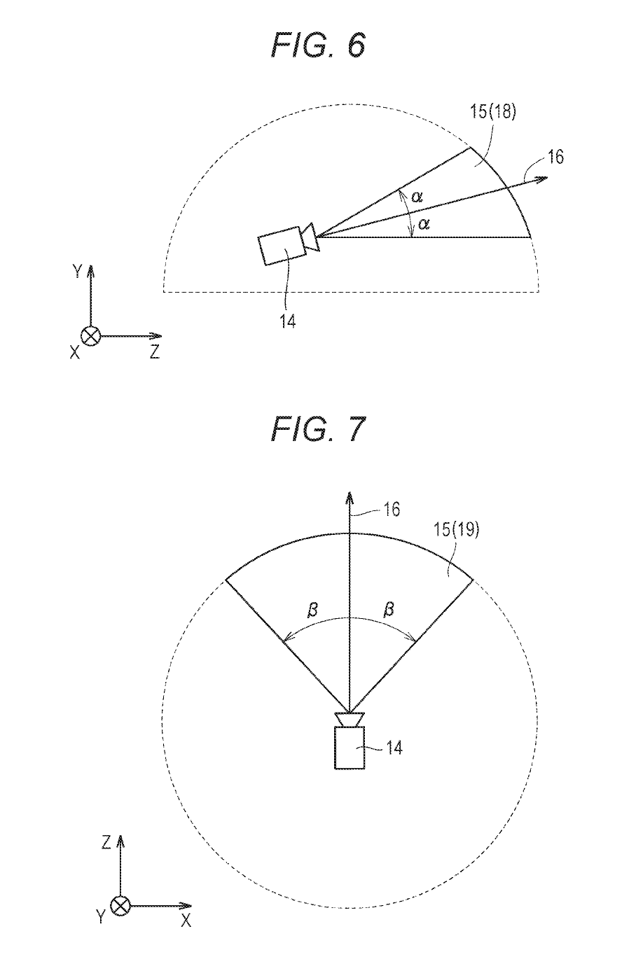

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth P from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

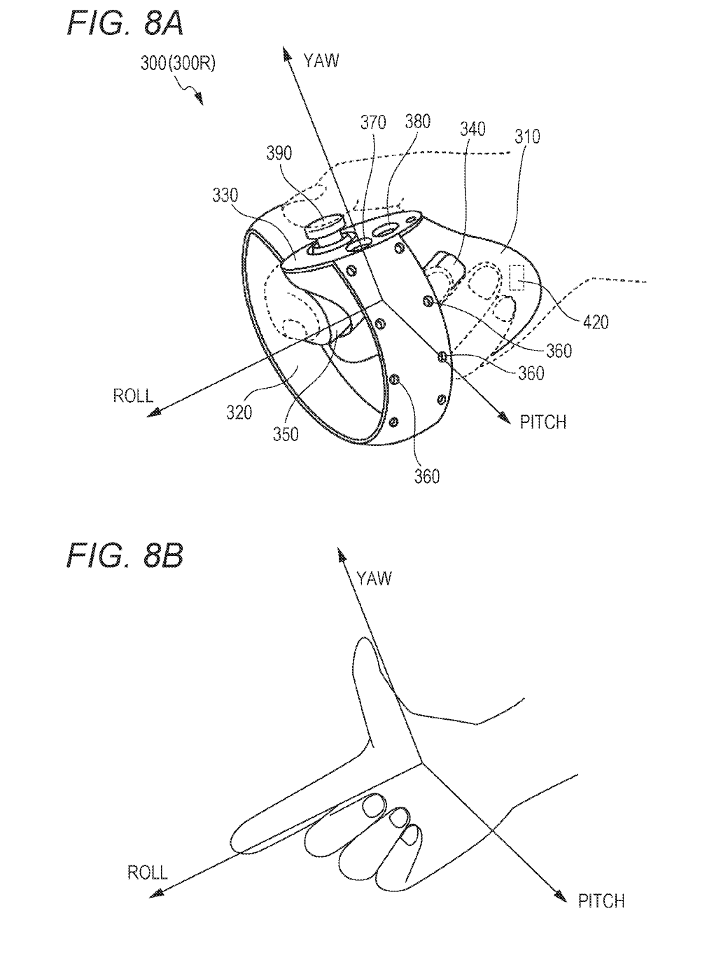

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

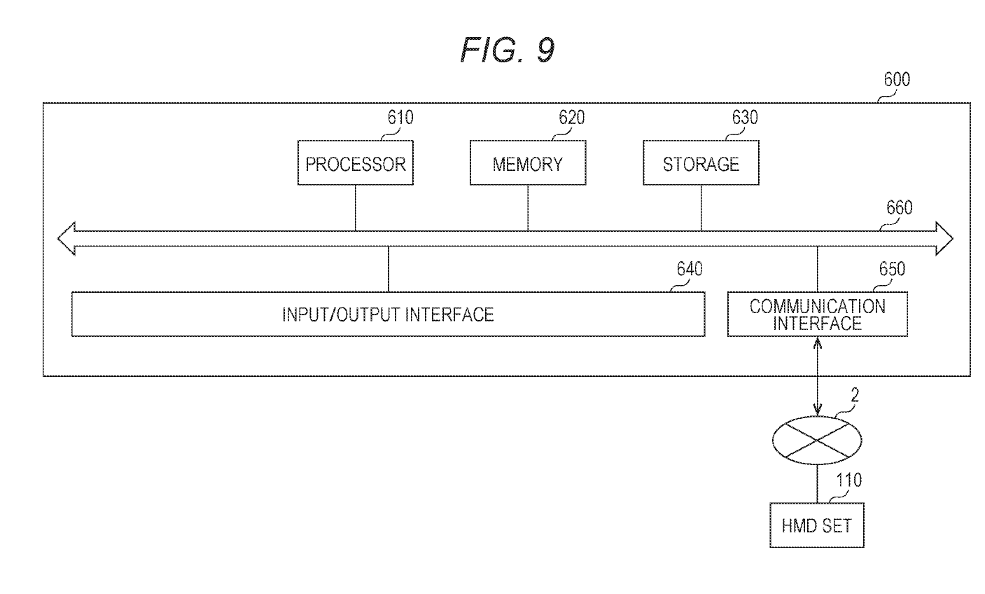

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

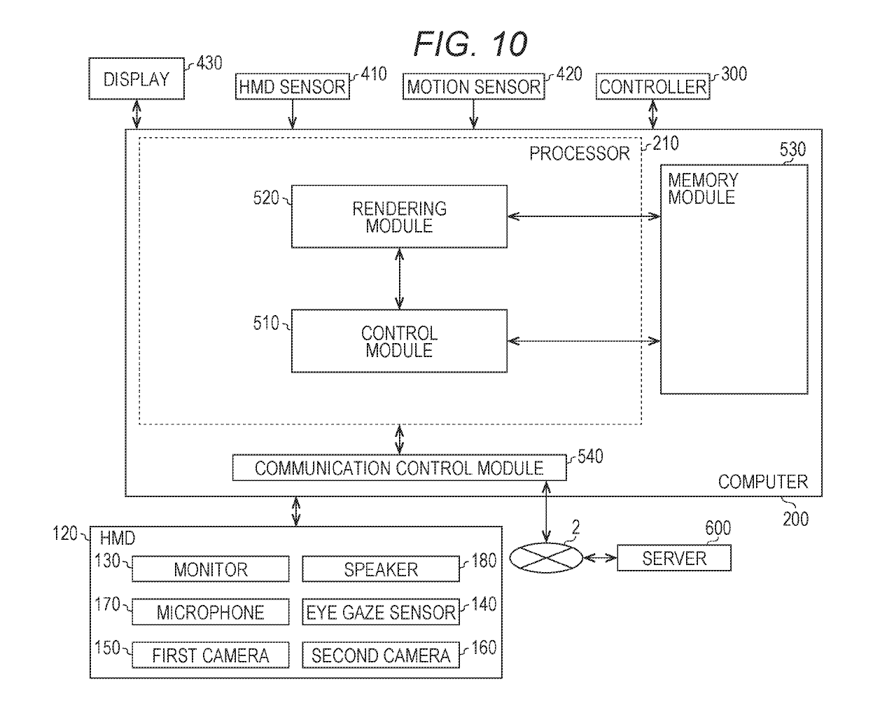

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

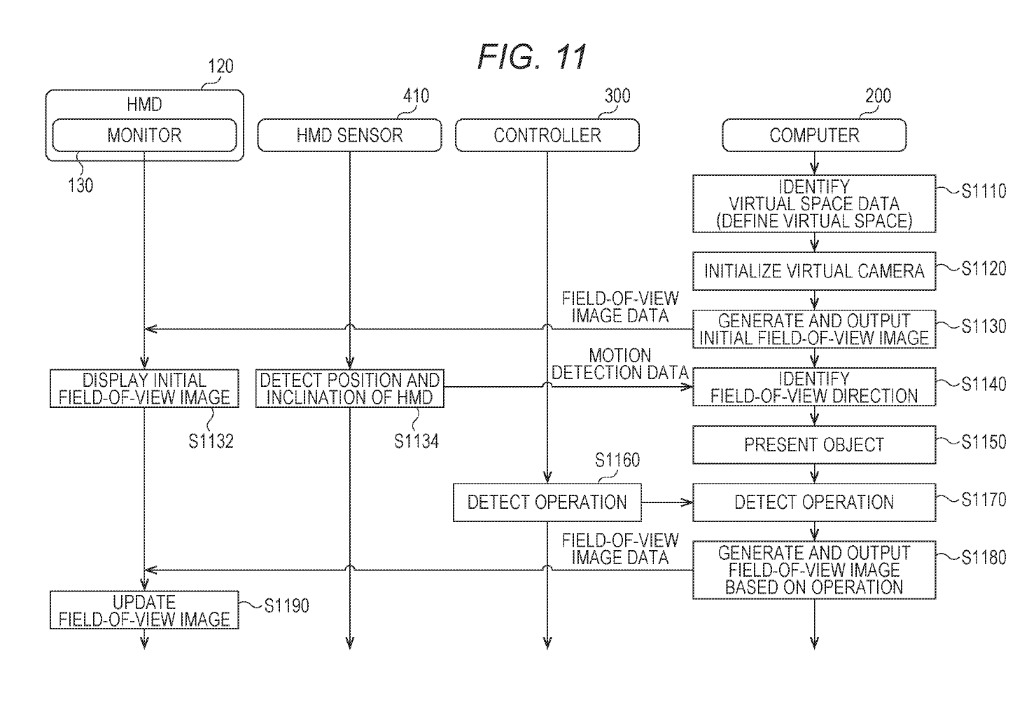

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5.

The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

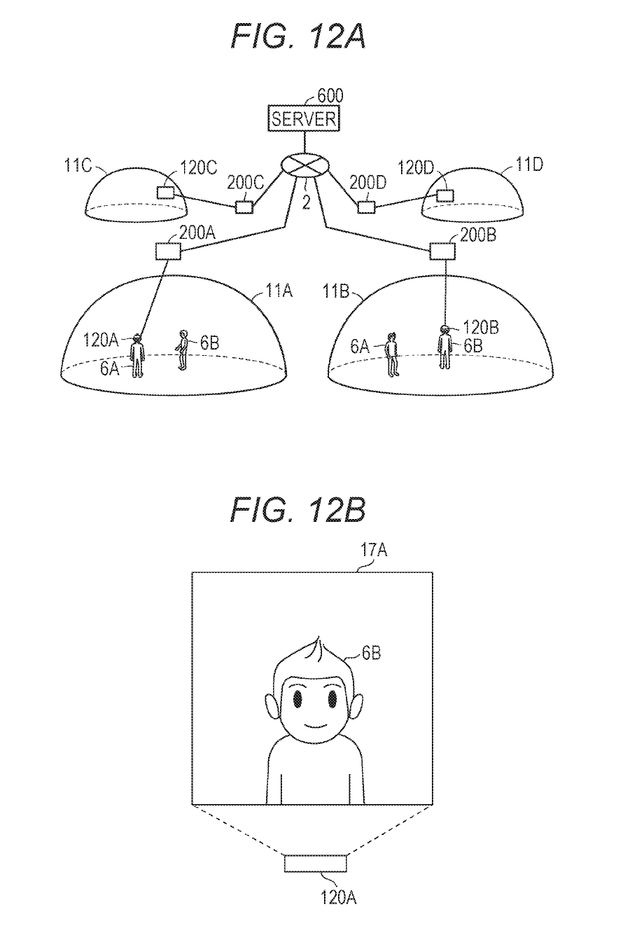

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

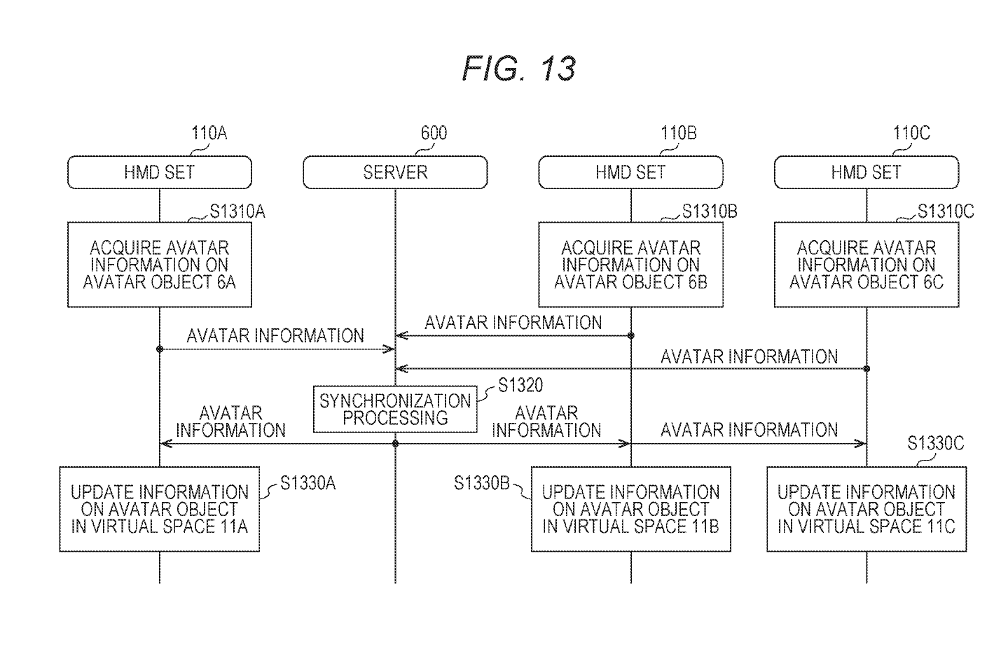

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Technical Concept]

The following description is an outline of a technical concept according to at least one embodiment of this disclosure. There is now described a case in which a comment from a viewer of content distributed live is presented on the monitor of the HMD worn by the distributor (commentator) of the content.

(A) The computer generating a video signal for presentation on the HMD of the commentator in accordance with play by the commentator transmits the video signal to the distribution server of the content.

(B) The distribution server distributes a video signal relating to the play by the commentator (e.g., video signal corresponding to result of motion or operation of controller) to the other connected (logged in) terminals. At this time, the computer (e.g., above-mentioned computer or distribution server) generating a field-of-view image obtained by photographing the virtual space controls the arrangement of the virtual camera arranged in the virtual space and updates the field-of-view image.

(C) A terminal connected to the distribution server receives from the distribution server the video signal relating to the live distribution, plays back the video, receives input of a comment by the user (viewer) of the terminal, and transmits the comment to the distribution server.

(D) The distribution server identifies the apparatus (e.g., computer to which HMD is connected) of the live video distributor (commentator), and transmits to the apparatus of the commentator the comment input from the terminal.

(E) The monitor of the HMD worn by the commentator displays the comment received from the distribution server. At this time, the comment may be displayed at a place that does not disturb the video, for example, at the edge of the display region or behind objects presented in the virtual space. The characters forming the comment may be displayed in translucent letters. The comment may also be temporarily displayed. For example, the comment is displayed, or not displayed, at the timing at which the field-of-view image is switched.

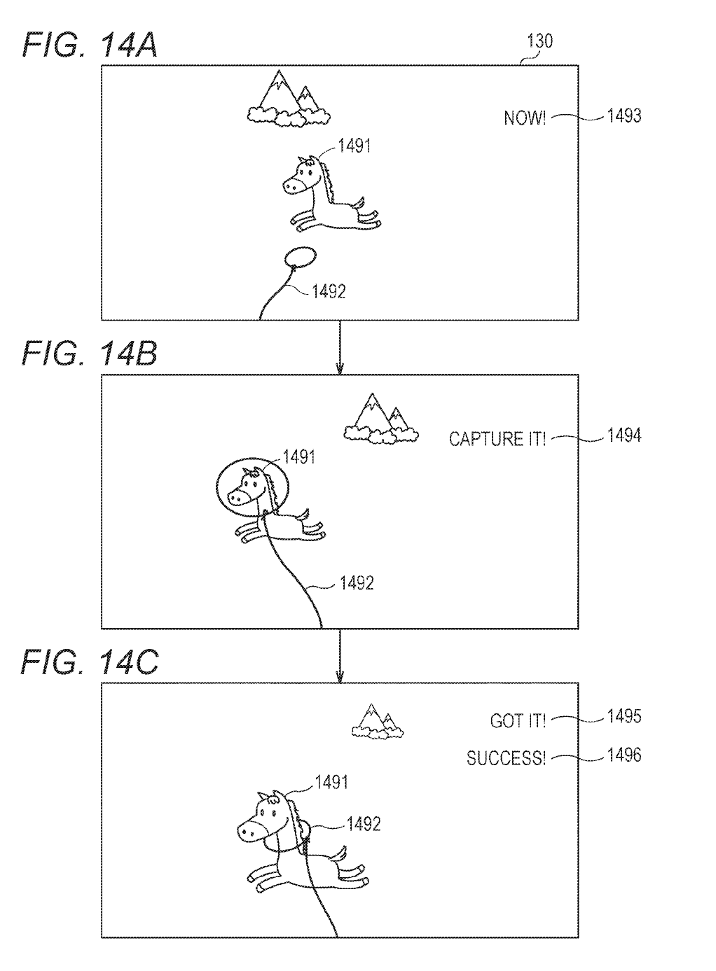

An implementation example of the technical concept according to at least one embodiment of this disclosure is now described with reference to FIG. 14A to FIG. 14C. FIG. 14A to FIG. 14C are diagrams of transitions of the screen displayed on the monitor 130 providing the virtual space according to at least one embodiment of this disclosure. The monitor 130 is, for example, arranged on the HMD or mounted to the HMD. The monitor 130 presents objects and comments based on a program executed by a computer connected to the HMD or incorporated in the HMD. There is now described a case in which the program on the monitor 130 presents a scene in which a horse running in the virtual space is captured by a rope.

[State A]

In at least one aspect, the monitor 130 displays a horse object 1491 and a rope object 1492 for capturing the horse object 1491. The monitor 130 also displays a comment 1493 (“Now!”). The comment 1493 is input from a computer used by another user other than the user of the HMD. The computer used by the another user may display the scene as either a two-dimensional image or an image in the virtual space.

[State B]

Next, when the user of the monitor 130 performs an operation to throw the rope object 1492 at the horse object 1491, the monitor 130 displays another comment 1494 (“Capture it!”) input by another user. The user who has input the comment 1493 and the user who has input the comment 1494 may be the same or different. In at least one aspect, the comment 1493 is displayed until the scene displayed on the monitor 130 switches, or for a time determined in advance. When the scene changes to the next scene, or when the time determined in advance elapses, the display of the comment 1493 is ended.

[State C]

When the user of the monitor 130 is successful in catching the horse object 1491 with the rope object 1492, the monitor 130 displays a comment 1495 (“Got it!”) and a comment 1496 (“Success!”). In this case as well, the user who has input the comment 1495 and the user who has input the comment 1496 may be the same or different. In this case as well, like with the case of the state B, when a condition determined in advance, including the conditions described above, is satisfied, the display of the comment is ended.

When a plurality of comments are to be displayed, the first comment may be displayed in a place designated in advance, and the next comment may be displayed at a position shifted from the first comment by a distance set in advance. As a result, the user can clearly confirm each comment. In at least one aspect, each comment may be sequentially displayed. For example, when the end of the content is displayed, each comment may be displayed in sequence. In this case, the display of the content has ended, and thus the problem of harming the sense of immersion can also be suppressed. In at least one aspect, the computer mounted to the HMD may receive input from the user of a comment in response to the comment displayed on the monitor 130, and transmit the input comment to another viewer. In this case, comments are exchanged between the user of the HMD and the viewer, thereby enabling dialogue between the users to be further promoted.

As is apparent from the comments 1493, 1494, and 1495, each comment is displayed in the same place even when the horse object 1491 to be presented in the virtual space moves. As a result, the visual recognizability of the comments is maintained without harming the sense of immersion in the virtual space. Each comment may be erased after being displayed for a fixed period of time determined in advance. Each comment may also be switched to another comment when the scene of the video switches.

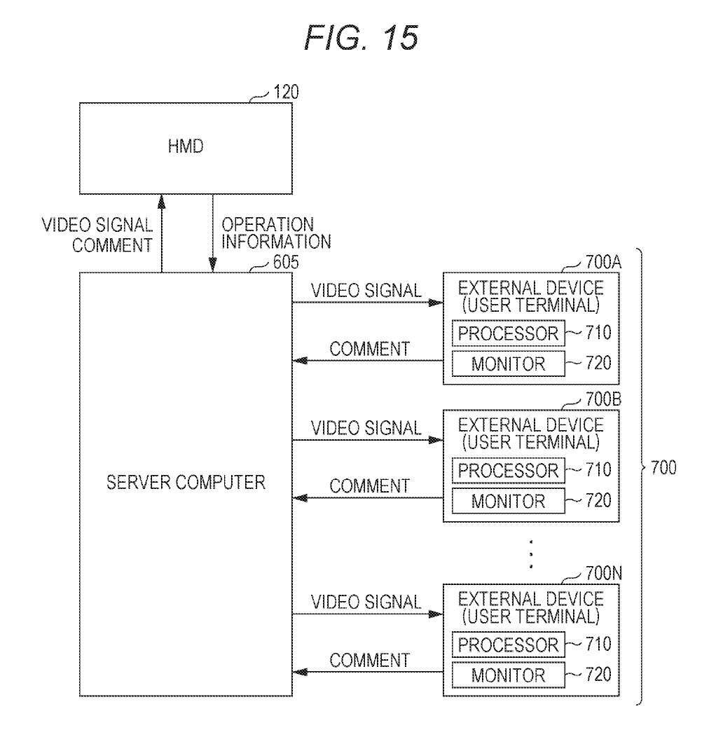

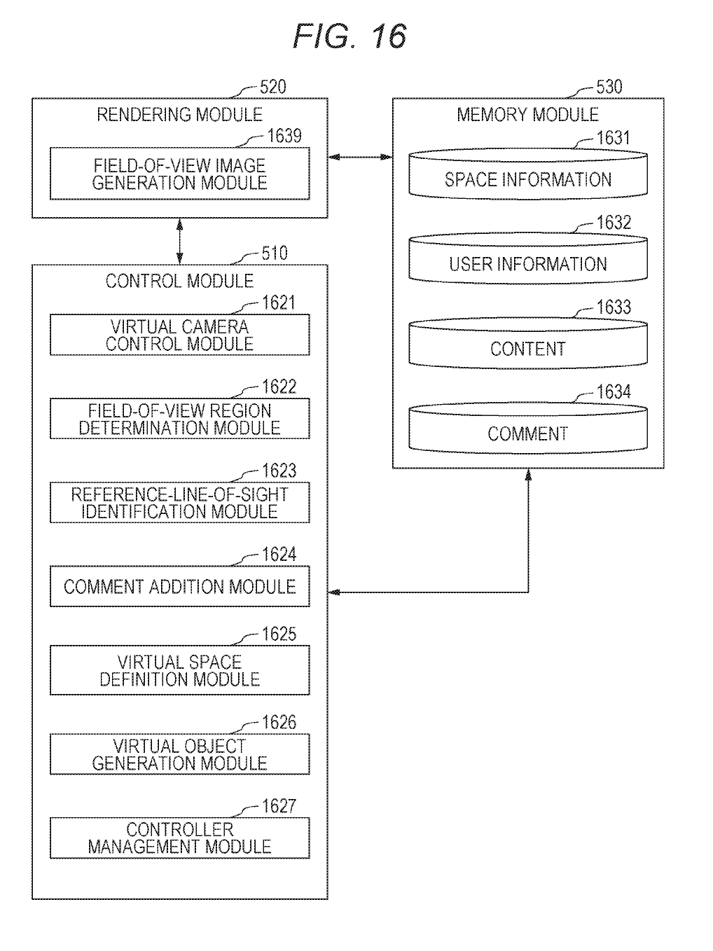

An apparatus configuration for implementing the technical concept according to at least one embodiment of this disclosure is now described with reference to FIG. 15. FIG. 15 is a schematic diagram of a configuration for adding a comment to the image presented in the virtual space according to at least one embodiment of this disclosure. The virtual space is provided by the HMD 120. The HMD 120 is communicably connected to a server computer 605 having a known configuration. The server computer 605 is communicably connected to one or more external devices (user terminals) 700A, 700B, and 700N (collectively referred to as “external device 700”). Each external device 700 includes a processor 710 and a monitor 720. In at least one aspect, the external device 700 is, for example, a computer, a tablet terminal, a smartphone, or other information communication terminal having a known configuration. In at least one aspect, the external device 700 is implemented by the computer of the user and the HMD connected to that computer similarly to the HMD 120.

The HMD 120 displays a video on the monitor 130 based on a video signal transmitted from the server computer 605. When the user operates the controller, the HMD 120 transmits information representing the operation to the server computer 605. The server computer 605 executes, based on the information, for example, processing for moving an object included in the image presented on the HMD 120, and displays to the HMD 120 and the logged-in external devices 700A, 700B, and 700N a video signal for displaying the processed image. The format of the video signal transmitted to the HMD 120 and the format of the video signal transmitted to the external devices 700A, 700B, and 700N may be the same or different. The video signal transmitted to the HMD 120 is three-dimensional data to be used in the virtual space while maintaining the sense of immersion. On the other hand, the video signal transmitted to the external devices 700A, 700B, and 700C may be data for displaying an image in two dimensions when a sense of immersion is not required.

Each user of the external devices 700A, 700B, and 700N is able to visually recognize the same image as the image seen by the user of the HMD 120. At this time, each user is able to input a comment regarding the image by using a touch panel, a mouse, a sound input device, or other input device. The input comment is transmitted to the server computer 605. The server computer 605 superimposes and displays the comment on the edge of the field-of-view region, for example, so as not to disturb the image presented on the HMD 120. The server computer 605 may also display the comment in a translucent color. The user wearing the HMD 120 is able to visually recognize the comment while confirming the image presented in the virtual space.

### DETAILED DESCRIPTION

[Details of Module Configuration]

With reference to FIG. 14, details of a module configuration of the computer 200 are described. FIG. 14 is a block diagram of a configuration of modules of the computer 200 according to at least one embodiment of this disclosure.

In FIG. 14, the control module 510 includes a virtual camera control module 1621, a field-of-view region determination module 1622, a reference-line-of-sight identification module 1623, a comment addition module 1624, a virtual space definition module 1625, a virtual object generation module 1626, and a controller management module 1627. The rendering module 520 includes a field-of-view image generation module 1639. The memory module 530 stores space information 1631, user information 1632, content 1633, and a comment 1634.

In at least one aspect, the control module 510 controls image display on the monitor 130 of the HMD 120. The virtual camera control module 1621 arranges the virtual camera 14 in the virtual space 11, and controls the behavior, direction, and the like of the virtual camera 14. The field-of-view region determination module 1622 defines the field-of-view region 15 in accordance with the direction of the head of the user wearing the HMD 120. The field-of-view image generation module 1639 generates, based on the determined field-of-view region 15, a field-of-view image 17 to be displayed on the monitor 130.

The reference-line-of-sight identification module 1623 identifies the line of sight of the user 5 based on the signal from the eye gaze sensor 140. The comment addition module 1624 superimposes the comment received via the server 600 onto the field-of-view image generated by the field-of-view image generation module 1639.

The control module 510 controls the virtual space 11 provided to the user 5. The virtual space definition module 1625 defines the virtual space 11 in the HMD system 100 by generating virtual space data representing the virtual space 11. The virtual object generation module 1626 generates a target object to be arranged in the virtual space 11. Examples of the target object include an object constructing a mountain, a tree, or other background, an animal object (e.g., horse object 1491) to be presented in accordance with the story in the program implemented by the computer 200, and an object (e.g., rope object 1492) for capturing the animal object.

The controller management module 1627 receives the motion of the user 5 in the virtual space 11 and controls the controller object in accordance with the motion. The controller object in at least one embodiment functions as a controller for issuing instructions to other objects arranged in the virtual space 11. In at least one aspect, the controller management module 1627 generates data for arranging in the virtual space 11 a controller object for receiving a control in the virtual space 11. When the HMD 120 receives this data, the monitor 130 may display the controller object.

The space information 1631 stores one or more templates defined in order to provide the virtual space 11. The user information 1632 includes identification information on the user 5 of the HMD 120, an authority associated with the user 5, and the like. The authority includes, for example, account information (user ID, password) and the like for accessing a website providing an application. The content 1633 includes, for example, content presented by the HMD 120. The comment 1634 is a comment input by any one of the external devices 700A to 700N.

[Configuration of Server Computer]

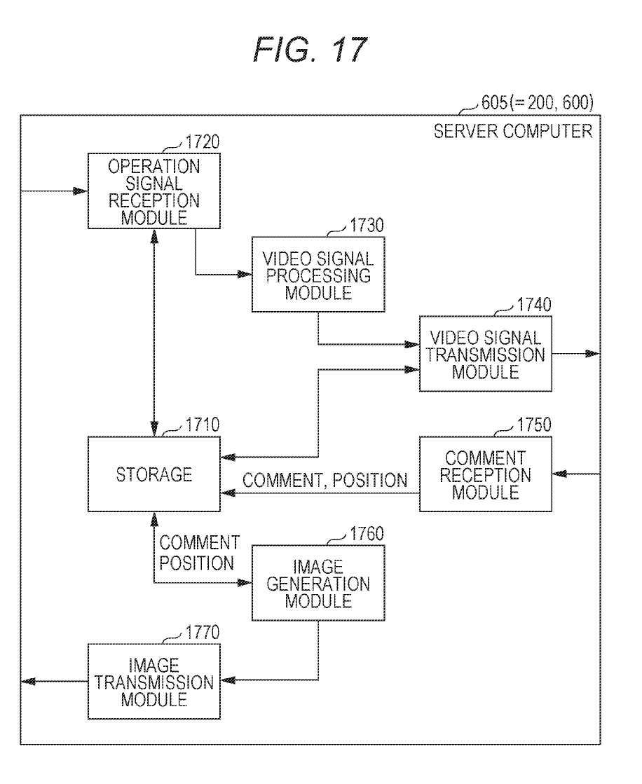

The configuration of the server computer 605 is now described in more detail with reference to FIG. 17. FIG. 17 is a block diagram of a configuration of functions implemented by the server computer 605 according to at least one aspect of this disclosure. The server computer 605 includes a storage 1710, a signal reception module 1720, a video signal processing module 1730, a video signal transmission module 1740, a comment reception module 1750, an image generation module 1760, and an image transmission module 1770.

The storage 1710 stores data and programs input to the server computer 605. For example, the storage 1710 stores the data transmitted from the HMD 120, comments input by any one of the external devices 700A, 700B, and 700N, and the distribution destination of the content displayed on the HMD 120. The storage 1710 may be implemented as the memory module 530 by, for example, a flash memory, a hard disk device, or other nonvolatile memory, and a volatile memory such as a random-access memory (RAM).

The signal reception module 1720 receives the video signal transmitted from the HMD 120 or the computer 200. The signal reception module 1720 is implemented as the communication control module 540.

The video signal processing module 1730 converts the format of the video signal received by the signal reception module 1720 into a signal having a format suitable for display on the external devices 700A, 700B, and 700N. For example, a video signal for displaying a three-dimensional image on the HMD 120 is converted into a video signal for displaying a two-dimensional image on each external device 700. The video signal processing module 1730 is implemented by the control module 510.

The video signal transmission module 1740 transmits the video signal generated by the video signal processing module 1730 to the external device 700 registered in the storage 1710 as a distribution destination. When the external device 700 displays an image based on the video signal, the user of the external device 700 is able to recognize the image visually recognized by the user 5 wearing the HMD 120. When the user of the external device 700 inputs a comment regarding the image and performs a transmission operation, the comment is transmitted to the server computer 605. At this time, position information specifying the place at which the comment is to be displayed is also transmitted to the server computer 605. The video signal transmission module 1740 is implemented by the communication control module 540.

The comment reception module 1750 receives the comment and the position information transmitted from the external device 700. The comment reception module 1750 is implemented by the communication control module 540, for example. The received comment and position information are stored in the storage 1710.

The image generation module 1760 generates a comment image to be presented on the HMD 120 by using the comment and position information stored in the storage 1710. For example, the image generation module 1760 generates the comment image such that the comment is displayed at the same place in the field-of-view region image regardless of the direction and position of the HMD 120. The image generation module 1760 may be implemented as the field-of-view image generation module 1639 and the comment addition module 1624 by, for example, the control module 510 and the rendering module 520.

The image transmission module 1770 transmits the comment image generated by the image generation module 1760 to the HMD 120. The HMD 120 is capable of visually recognizing an image in which the image of the content and the comment image are superimposed on each other. At this time, the position of the comment image is determined to be at a predetermined fixed place regardless of the position and direction of the HMD 120.

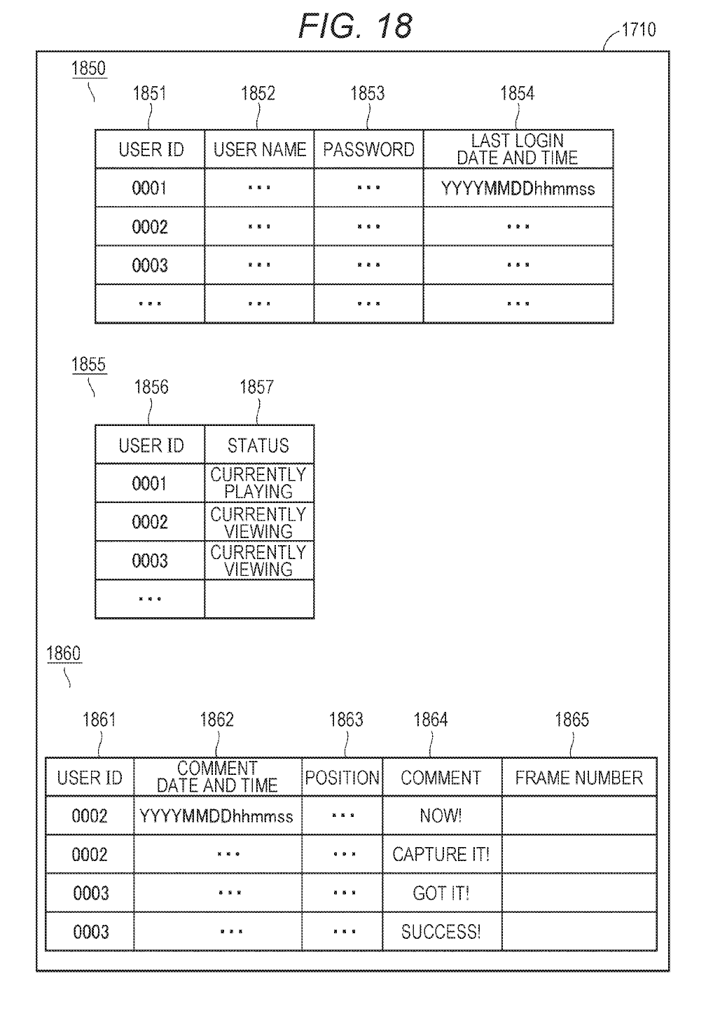

The data structure of server computer 605 is now described with reference to FIG. 18. FIG. 18 is a schematic diagram of one mode of storing data in the storage 1710 according to at least one embodiment of this disclosure. The storage 1710 stores tables 1850, 1855, and 1860. The table 1850 includes a user ID 1851, a user name 1852, a password 1853, and a last login date and time 1854. The table 1855 includes a user ID 1856 and a status 1857. The table 1860 includes a user ID 1861, a comment date and time 1862, a position 1863, a comment 1864, and a frame number 1865.

The table 1850 is used for managing information on users sharing certain content. More specifically, the user ID 1851 represents identification data of the users registered for a distribution site. The user name 1852 represents the name of each user. The password 1853 represents a password required for login. The last login date and time 1854 represents the date and time when the user last logged in.

The table 1855 is used for managing the state of the user for the relevant content. More specifically, the user ID 1856 represents the identification data of the users who are currently logged in. The status 1857 indicates the current state of the user, for example, whether the user is playing the content, or whether he or she is simply viewing the content.

The table 1860 is used for managing comments input by each user. More specifically, the user ID 1861 identifies the user who wrote the comment. The comment date and time 1862 represents the date and time when the comment was written. The position 1863 represents the position at which the comment is displayed. 1864 represents the details of the comment. The frame number 1865 is the number of the frame in which the content is contained. The frame number 1865 represents position information of the content in which the comment is written. In at least one aspect, in place of the frame number 1865, time information identifying the playback position of the content is stored as the position information. After the playback of a piece of content has ended, when playback of that content is specified at a separate date and time, the processor of the server computer 605 can refer to the table 1860, read the comments written for that content, and present the comments together with the content to the viewer.

[Control Structure]

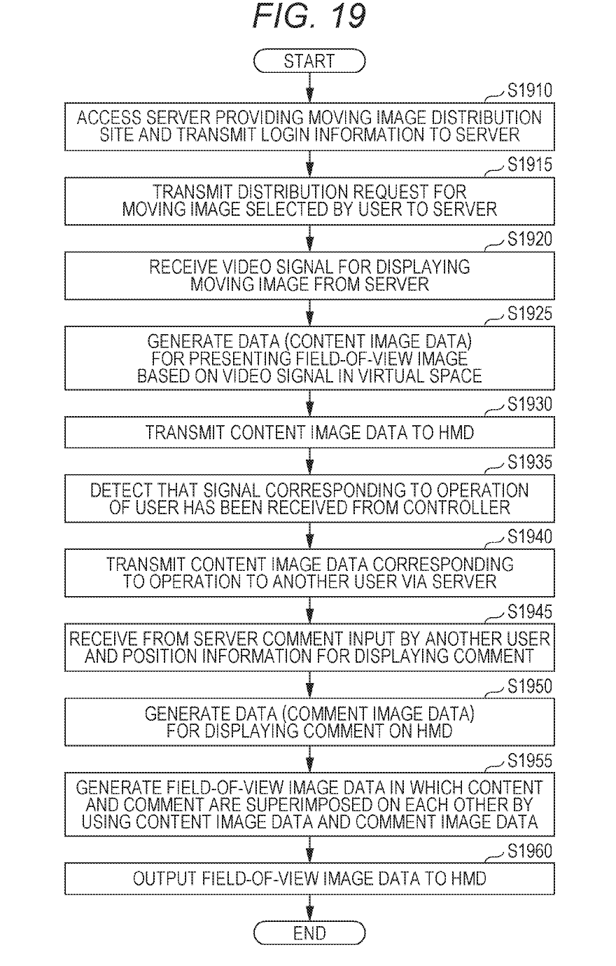

A control structure of the server computer 605 is now described with reference to FIG. 19. FIG. 19 is a flowchart of a part of processing to be executed when the server computer 605 is implemented by the computer 200 according to at least one embodiment of this disclosure.

In Step S1910, the processor 210 accesses, via the communication control module 540, the server 600 providing the moving image distribution site, and transmits login information to the server 600.

In Step S1915, the processor 210 transmits, via the communication control module 540, a distribution request for content selected by the user 5 (e.g., 360-degree moving image, game application, or chat application) to the server 600. In response to the request, the server 600 transmits the content to the server computer 605.

In Step S1920, the processor 210 receives, via the communication control module 540, a video signal for displaying a moving image from the server 600.

In Step S1925, the processor 210 serves as the field-of-view image generation module 1639 to generate data (content image data) for presenting a field-of-view image based on the video signal in the virtual space.

In Step S1530, the processor 210 transmits the content image data to the HMD 120.

In Step S1935, the processor 210 detects, based on a signal from the controller 300, that a signal corresponding to the operation of the user 5 has been received.

In Step S1940, the processor 210 serves as the field-of-view image generation module 1639 to generate content image data corresponding to the operation, and transmits the generated content image data to the user terminal (e.g., external device 700A, 700B . . . 700N) or the like of another user via the server 600.

In Step S1945, the processor 210 receives from the server 600 via the communication control module 540 a comment input by another user and position information for displaying the comment.

In Step S1950, the processor 210 generates data (comment image data) for displaying the comment on the HMD 120. In at least one aspect, the processor 210 generates data for displaying the comment on the HMD 120 separately from the image data based on the application for displaying the virtual space presented to the HMD 120.

In Step S1955, the processor 210 serves as the comment addition module 1624 to generate field-of-view image data in which the content and the comment are superimposed on each other by using the content image data and the comment image data.

In Step S1960, the processor 210 outputs the field-of-view image data to the HMD 120. The user 5 may recognize the comment displayed on the monitor 130.

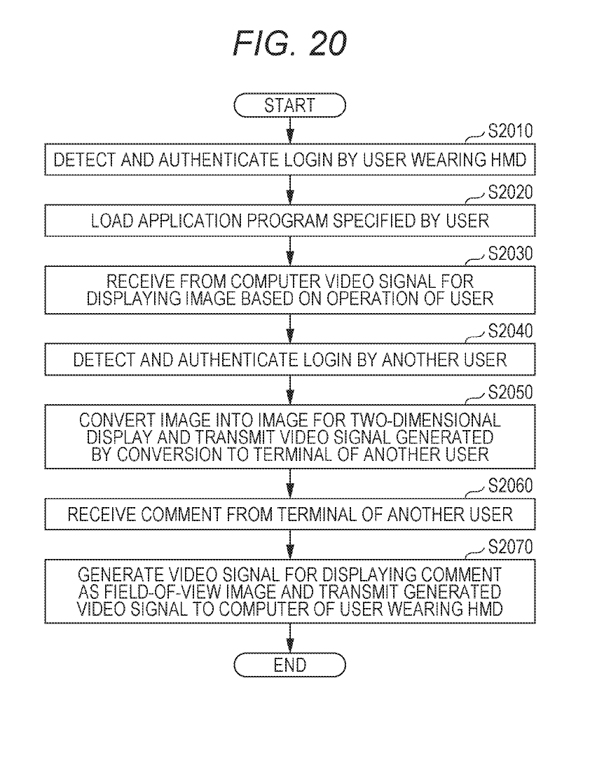

The control structure of the server computer 605 in at least one embodiment is now described with reference to FIG. 20. FIG. 20 is a flowchart of a part of processing to be executed when the server computer 605 is implemented by the server 600 according to at least one embodiment of this disclosure.

In Step S2010, the processor 610 of the server 600 detects, based on a signal transmitted from the computer 200, login by the user 5 wearing the HMD 120, and executes authentication processing by using the user ID and password included in the received signal and a user ID and password stored in advance as registration information.

In Step S2020, the processor 610 of the server 600 loads the application program specified by the user 5 into the RAM from the storage device. The processor 610 executes the loaded application program, and transmits to the computer 200 a video signal based on the execution. The HMD 120 displays the content in the virtual space 11 based on the video signal. The user 5 may operate the controller 300 while watching the content. Investigation information is transmitted from the controller 300 to the computer 200, and the display of the content is changed.

In Step S2030, the processor 610 of the server 600 receives from the computer 200 a video signal for displaying an image based on the operation of the user.

In Step S2040, the processor 610 of the server 600 detects, based on a signal received from the external device 700A or the like, login by another user, and executes authentication processing by using the user ID and password. When it is confirmed that the login is requested by an authorized user registered in advance, the server 600 is accessed by that external device 700A or the like.

In Step S2050, the processor 610 of the server 600 converts an image visually recognized as a three-dimensional image into an image for two-dimensional display, and transmits the video signal generated by the conversion to the external device 700A or the like of the another user. The external device 700A displays the same content as the content visually recognized by the user 5 on the monitor, and hence the another user can also enjoy that content. The another user can input a comment for the user 5 by using an input device while watching the content. The input comment is transmitted to the server 600 together with the position information.

In Step S2060, the processor 610 of the server 600 receives a comment from any one of the external devices 700A, 700B, . . . 700N of the other users.

In Step S2070, the processor 610 of the server 600 generates a video signal for displaying the comment as the field-of-view image, and transmits the generated video signal to the computer 200 of the user 5 wearing the HMD 120. The monitor 130 of the HMD 120 may display the comment such that the comment is superimposed on the image of the content.

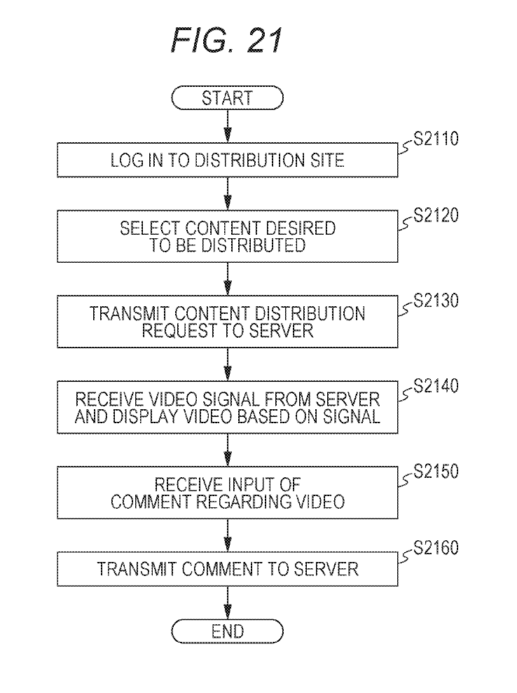

The control structure of the terminal of another user is now described with reference to FIG. 21. FIG. 21 is a flowchart of a part of processing to be executed by the external device 700A of another user according to at least one embodiment of this disclosure.

In Step S2110, based on an operation of another user, the processor 710 logs in to the distribution site displayed on the monitor 720. In Step S2120, based on an operation of the another user, the processor 710 receives a selection of the content desired to be distributed. For example, the another user may select the content that the user 5 is viewing. In Step S2130, the processor 710 transmits a content distribution request to the server 600.

In Step S2140, the processor 710 receives a video signal from the server 600, and displays on the monitor 720 a video based on that signal. In Step S2150, the processor 710 receives input of a comment regarding the video via an input interface, such as a mouse, a keyboard, a touch panel, and the like.

In Step S2160, the processor 710 transmits the comment to the server 600. When the server 600 transmits this comment to the computer 200 to which the HMD 120 is connected, the comment is displayed on the monitor 130.

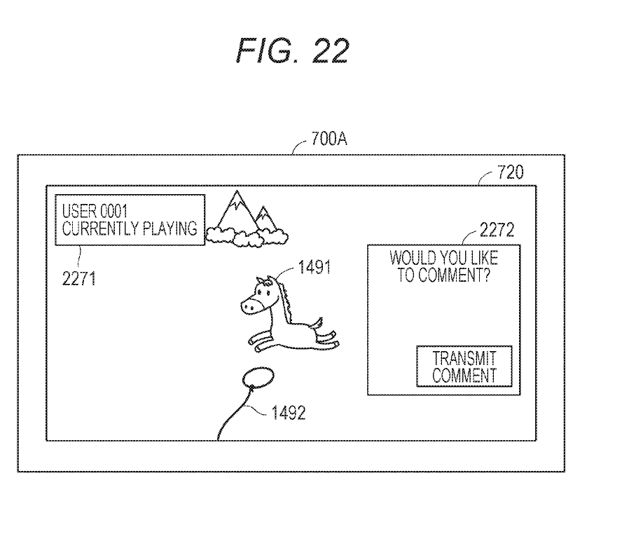

A display mode of the screen in the external device 700A is now described with reference to FIG. 22. FIG. 22 is a diagram of an example of the screen displayed on the monitor 720 of the external device 700A according to at least one embodiment of this disclosure. In at least one aspect, the monitor 720 displays the same content as the content displayed on the monitor 130 of the HMD 120 worn by the user 5. The monitor 720 also displays an image 2271 indicating that the user who is playing is the user 5 (=user 0001) and an image 2272 prompting transmission of a comment. The image 2271 and the image 272 are, for example, pop-up images.

For example, when the external device 700A starts displaying the content displayed on the monitor 130, the monitor 720 displays the image 2271 for a time determined in advance. In at least one aspect, when the user 5 operates the controller 300 the image 2271 is displayed in response to the operation. In this case, when the scene changes in response to the operation, the another user using the external device 700A is able to know the user who is playing.

In at least one aspect, the image 2272 is displayed at time intervals determined in advance. In at least one aspect, like the image 2271, the image 2272 is displayed in response to the timing at which the user 5 has performed a given operation. In this case, it becomes more difficult for other users to miss the input timing for a comment in response to the operation of the user 5, and hence, as in FIG. 14A to FIG. 14C, for example, the comments of other users are also promptly displayed on the monitor 130. As a result, it is easier for the user 5 to visually recognize timely comments.

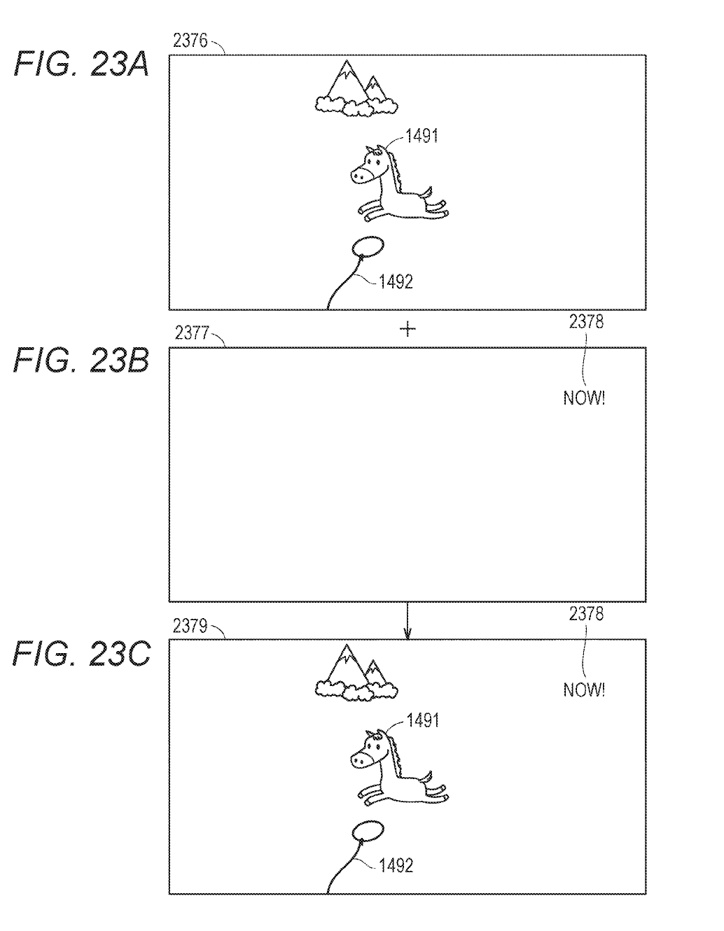

Display of the content and the comments on the monitor 130 is now described with reference to FIG. 23A to FIG. 23C. FIG. 23A to FIG. 23C are schematic diagrams of a flow of data generation for displaying an image on the monitor 130 according to at least one embodiment of this disclosure.

In FIG. 23A, in at least one aspect, the memory 210 stores rendering data 2376 for displaying content on the monitor 130 in a portion of a work area. The content includes a horse object 1491 and a rope object 1492.

In FIG. 23B, the memory 210 stores rendering data 2377 for displaying a comment 2378 input by another user in another work area different from the above-mentioned work area. The rendering data 2377 is generated after the comment 2378 has been received by the computer 200. The place in which the comment 2378 is displayed is maintained at a fixed place of the monitor 130 regardless of the direction and posture of the HMD 120. Therefore, for example, even when the line-of-sight direction (direction of virtual camera 14) has moved as a result of the horse object 1491 moving in the virtual space 11, the comment 2378 is displayed at the fixed position of the monitor 130. Such a positional relationship for display is maintained, for example, by setting the display region of the monitor 130 as the coordinate values of the absolute position and defining the display location of the comment 2378 in association with those coordinate values of the absolute position.

In FIG. 23C, the memory 210 stores rendering data 2379 in still another work area. The rendering data 2379 is generated by configuring the rendering data 2376 and the rendering data 2377. When the processor 210 transmits the rendering data 2379 to the HMD 120, the monitor 130 displays an image like that illustrated in FIG. 14A. Comments are similarly displayed on the other images as well (FIG. 14B and FIG. 14C).

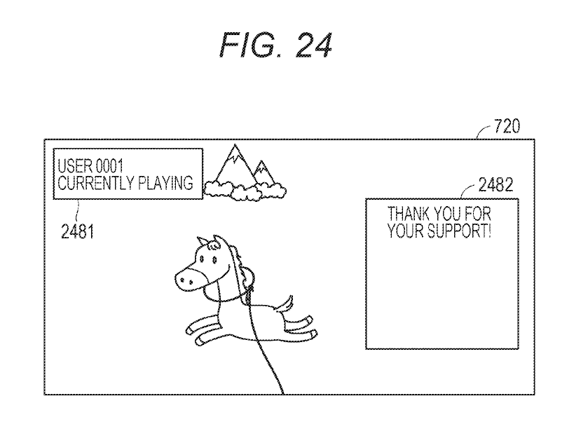

A display mode of the screen in the external device 700 is now described with reference to FIG. 24. FIG. 24 is a diagram of one mode of a screen on which a comment input by the user 5 is displayed on the monitor 720 of the external device 700 of another user according to at least one embodiment of this disclosure. The monitor 720 displays an image 2481 and an image 2482 in addition to the image of the virtual space displayed on the monitor 130 of the HMD 120. The image 2481 represents the user 5 who is playing. The image 2482 represents a comment input by the user 5. For example, when the user 5 inputs a response comment after enjoying the content, the response comment is transmitted to the another user who has transmitted the comment to the user 5. In this way, through transmission of comments between another user and the user 5, dialogue between the user 5 and the another user may be promoted.

The technical features according to at least one embodiment of this disclosure may be summarized as follows.

(Configuration 1)

A method to be executed by a server computer 605 in order to control a display in an HMD 120 configured to provide a virtual space 11 includes transmitting to the HMD 120 a video signal for displaying a video corresponding to an operation of a user 5 of the HMD 120. The method further includes transmitting the video signal to one or more external devices 700A, 700B, 700N, and the like communicatively connected to the server computer 605. The method further includes receiving from the one or more external devices 700A, 700B, 700N, and the like a viewer response (e.g., comments 1493, 1494, 1495, and 1496) issued regarding the video displayed on the one or more external devices 700A, 700B, 700N, and the like based on the video signal. The method further includes presenting the viewer response on the monitor 130 of the HMD 120.

(Configuration 2)

In Configuration 1, the transmitting of the video signal to the one or more external devices 700A, 700B, 700N, and the like includes transmitting to the one or more external devices 700A, 700B, 700N, and the like a signal for displaying a two-dimensional image.

(Configuration 3)

In Configuration 1, the receiving of the viewer response from the one or more external devices 700A, 700B, 700N, and the like includes receiving position information specifying a place at which the viewer response is to be presented in the virtual space 11.

(Configuration 4)

In Configuration 3, the receiving of the viewer response from the one or more external devices 700A, 700B, 700N, and the like includes receiving a viewer response from each of a plurality of the external devices 700A, 700B, 700N, and the like. The receiving of the position information includes receiving the position information on each of the external devices 700A, 700B, 700N, and the like. The presenting of the viewer response on the monitor 130 includes presenting, when the position information indicates the same position, the viewer responses separately from each other.

(Configuration 5)

In any one of Configurations 1 to 4, the receiving of the viewer response from the one or more external devices 700A, 700B, 700N, and the like includes receiving a plurality of viewer responses from the one or more external devices 700A, 700B, 700N, and the like. The presenting of the viewer response includes overlaying and displaying any one of the plurality of viewer responses on another viewer response.

(Configuration 6)

In anyone of Configurations 1 to 5, the method further includes: receiving from the server computer 605 a user response entered by the user regarding the viewer response presented in the virtual space 11; and

transmitting a signal for displaying the user response to the one or more of the external devices 700A, 700B, 700N, and the like.

(Configuration 7)

In any one of Configurations 1 to 6, the method further includes erasing the viewer response presented in the virtual space 11.

(Configuration 8)

In any one of Configurations 1 to 7, the erasing of the viewer response includes erasing a comment in accordance with a change in an image presented in the virtual space 11.

(Configuration 9)

In anyone of Configurations 1 to 8, the method further includes storing the video signal and the viewer response into a storage device in association with other.

(Configuration 10)

In Configuration 9, the method further includes:

playing back a video based on the video signal; and

presenting a viewer response associated with the video signal in the virtual space 11 in accordance with playback of the video.

(Configuration 11)

In any one of Configurations 1 to 10, the method further includes:

detecting a motion of the user 5 of the HMD 120; and

presenting a field-of-view image of the virtual space 11 on the monitor 130 in association with the motion.

The presenting of the viewer response includes presenting the viewer response regardless of the motion.

As described above, according to the technology of at least one embodiment of this disclosure, when a user (viewer) of the external device 700 inputs a comment regarding a video provided to another external device 700 by the user 5 as a commentator, the comment is displayed in the video displayed by the HMD 120 of the user 5. For example, the comment is displayed at the edge of the display region or behind the objects presented in the virtual space 11. The comment may also be displayed as a pop-up display. In at least one aspect, the comment is overlaid and displayed on the screen of the game or other content. When a comment is displayed in this manner, the user 5 is able to confirm the comment without his or her sense of immersion being disturbed.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

What is claimed is:

1. A method of controlling display of a head-mounted device (HMD), the method comprising:
detecting a motion of the HMD associated with a first user;
outputting to the HMD a video corresponding to the motion of the HMD;
outputting the video to a display terminal associated with a second user different from the first user;
receiving input associated with the video from the display terminal by receiving input to the display terminal by the second user; and
outputting an image corresponding to the input to the HMD.

2. The method according to claim 1, further comprising:
outputting the video substantially simultaneously to the HMD and the display terminal;
receiving the input from the display terminal while the video is displayed on the HMD and the display terminal; and
outputting an image corresponding to the input to the HMD and the display terminal while the video is displayed on the HMD and the display terminal.

3. The method according to claim 1, further comprising transmitting output for causing the display terminal to display an indication prompting the second user of the input regarding the video to the display terminal while the video is displayed on the HMD and the display terminal.

4. The method according to claim 1, wherein the receiving of the input from the display terminal comprises receiving position information specifying a position at which an image corresponding to the input is to be displayed on the HMD.

5. The method according to claim 1,
wherein the receiving of the input from the display terminal comprises:
receiving a second input associated with the video from a second display terminal associated with the second user; and
receiving a third input associated with the video from a third display terminal associated with a third user different from the first user and the second user, and
wherein a position at which an image corresponding to the second input is to be displayed on the HMD and a position at which an image corresponding to the third input is to be displayed on the HMD are different from each other.

6. The method according to claim 1,
wherein the receiving of the input from the display terminal comprises:
receiving a second input associated with the video from a second display terminal associated with the second user; and
receiving a third input associated with the video from a third display terminal associated with a third user different from the first user and the second user, and
wherein the method further comprises defining a position at which an image corresponding to the second input is to be displayed on the HMD and a position at which an image corresponding to the third input is to be displayed on the HMD such that the image corresponding to the second input and the image corresponding to the third input are superimposed on each other at least partially.

7. The method according to claim 1, further comprising erasing the image corresponding to the input in accordance with a change in the video satisfying a predetermined condition.

8. The method according to claim 1, further comprising:
defining a virtual space,
defining a visual field corresponding to the virtual space in accordance with the motion;
outputting a video corresponding to the visual field to the HMD; and
arranging in the virtual space an image corresponding to the input regardless of the motion.
